(19) United States
(12) Patent Application Publication
(10) Pub. No.: US 2024/0212184 A1
(43) Pub. Date: Jun. 27, 2024

(54) INTERMEDIATE VIEW SYNTHESIS BETWEEN WIDE-BASELINE PANORAMAS

(71) Applicant: Google LLC, Mountain View, CA (US)

(72) Inventors: Ruofei Du, San Francisco, CA (US); David Li, Gaithersburg, MD (US); Danhang Tang, West Hollywood, CA (US); Yinda Zhang, Palo Alto, CA (US)

(21) Appl. No.: 18/555,059

(22) PCT Filed: Apr. 30, 2021
(86) PCT No.: PCT/CN2021/091683

§ 371 Date: Oct. 12, 2023

(51) Int. Cl. G06T 7/55; G06T 5/77; G06T 7/181; G06T 15/00; G06T 17/20

(52) U.S. Cl. CPC G06T 7/55; G06T 5/77; G06T 7/181; G06T 15/00; G06T 17/20; G06T 2207/10028; G06T 2207/20081; G06T 2207/20084; G06T 2207/20221

(57) ABSTRACT

A method including predicting a stereo depth associated with a first panoramic image and a second panoramic image, the first panoramic image and the second panoramic image being captured with a time interlude between the capture of the first panoramic image and the second panoramic image, generating a first mesh representation based on the first panoramic image and a stereo depth corresponding to the first panoramic image, generating a second mesh representation based on the second panoramic image and a stereo depth corresponding to the second panoramic image, and synthesizing a third panoramic image based on fusing the first mesh representation with the second mesh representation.

### FIELD

Embodiments relate to panoramic image synthesis.

### BACKGROUND

Image synthesis, panoramic image synthesis, view synthesis, frame synthesis and/or the like can include generating an image based on at least one existing image and/or frame. For example, frame synthesis can include increasing a frame rate of a video by synthesizing one or more frames between two sequentially adjacent frames.

### SUMMARY

In a general aspect, a device, a system, a non-transitory computer-readable medium (having stored thereon computer executable program code which can be executed on a computer system), and/or a method can perform a process with a method including predicting a stereo depth associated with a first panoramic image and a second panoramic image, the first panoramic image and the second panoramic image being captured with a time interlude between the capture of the first panoramic image and the second panoramic image, generating a first mesh representation based on the first panoramic image and a stereo depth corresponding to the first panoramic image, generating a second mesh representation based on the second panoramic image and a stereo depth corresponding to the second panoramic image, and synthesizing a third panoramic image based on fusing the first mesh representation with the second mesh representation.

Implementations can include one or more of the following features. For example, the first panoramic image and the second panoramic image can be 360-degree, wide-baseline equirectangular projection (ERP) panoramas. The predicting of the stereo depth can estimate a depth of each of the first panoramic image and the second panoramic image using a spherical sweep cost volume based on the first panoramic image and the second panoramic image and at least one target position. The predicting of the stereo depth can estimate a low-resolution depth based on a first features map associated with the first panoramic image and the second panoramic image, and the predicting of the stereo depth can estimate a high-resolution depth based on the first features map and a second features map associated with the first panoramic image. The generating of the first mesh representation can be based on the first panoramic image and discontinuities determined based the stereo depth corresponding to the first panoramic image, and the generating of the second mesh representation can be based on the second panoramic image and discontinuities determined based on the stereo depth corresponding to the second panoramic image.

The generating of the first mesh representation can include rendering the first mesh representation into a first 360-degree panorama based on a first target position, the generating of the second mesh representation can include rendering the second mesh representation into a first 360-degree panorama based on a second target position, and the first target position and the second target position can be based on the time interlude between the capture of the first panoramic image and the second panoramic image. The synthesizing of the third panoramic image can include fusing the first mesh representation together with the second mesh representation, resolving ambiguities between the first mesh representation and the second mesh representation, and inpainting holes in the synthesized third panoramic image. The synthesizing of the third panoramic image can include generating a binary visibility mask to identify holes the first mesh representation based on negative regions in the stereo depth corresponding to the first panoramic image and the second mesh representation based on negative regions in the stereo depth corresponding to the second panoramic image. The synthesizing of the third panoramic image can include using a trained neural network, and the trained neural network can use circular padding at each convolutional layer, to join left and right edges of the third panoramic image.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1A illustrates a panoramic image capture sequence.

FIG. 1B illustrates a portion of a 360-degree video based on the captured panoramic images.

FIG. 1C illustrates a block diagram of a panoramic image synthesis flow according to an example embodiment.

FIG. 2 illustrates a block diagram of a panoramic image synthesis flow according to an example embodiment.

FIG. 3 illustrates a block diagram of a flow for predicting depth according to an example embodiment.

FIG. 4A illustrates a block diagram of a flow for training a model for predicting depth according to an example embodiment.

FIG. 4B illustrates a block diagram of a flow for training a model for panoramic image fusion according to an example embodiment.

FIG. 5 illustrates a block diagram of a method for generating a panoramic image sequence according to an example embodiment.

FIG. 6 illustrates a block diagram of a method for synthesizing a panoramic image according to an example embodiment.

FIG. 7 illustrates a block diagram of a method for predicting depth according to an example embodiment.

FIG. 8 illustrates a block diagram of a method for training a model for predicting depth according to an example embodiment.

FIG. 9 illustrates a block diagram of a method for training a model for panoramic image fusion according to an example embodiment.

FIG. 10 illustrates a block diagram of a computing system according to at least one example embodiment.

FIG. 11 shows an example of a computer device and a mobile computer device according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Recent advances in 360-degree cameras and displays capable of displaying 360-degree images, image sequences, video, and/or the like (e.g., virtual reality headsets) have promoted the interests of tourists, renters, photographers, and/or the like to capture or explore 360-degree images on computing platforms. These platforms can allow users to virtually walk through a city, preview a floorplan, and/or the like (e.g., indoor environments and outdoor environments) by interpolating between panoramas.

However, the existing solutions lack the visual continuity from one view to the next (e.g., from a first panorama image to a second panorama image) and suffer from ghosting artifacts caused by warping with inaccurate geometry. Existing systems for view synthesis of perspective images, a single image, and a pair of stereoscopic panoramas synthesize using a narrow baseline.

In addition, wide-baseline panoramas can be used for capturing and streaming sequences of panoramic images. Wide-baseline images (including wide-baseline panoramas) are images with a relatively large amount of camera motion (e.g., distance, rotation, translation, and/or the like) and change in internal parameters (of the camera) between two views (e.g., from a first panorama image to a second panorama image). For example, with frames of a movie camera motion and change in internal parameters can be relatively small between the first frame and the second frame in the video. However, the camera motion and change in internal parameters can be relatively large (e.g., a wide-baseline) between the first frame and the tenth frame, between the first frame and the one-hundredth frame, between the first frame and the one thousandth frame, and the like in the video.

Existing systems are limited when processing wide-baseline panoramas because existing systems do not include synthetization of an omnidirectional video with large movements (e.g., using a wide-baseline pair of panoramas). Therefore, existing platforms may not be configured to perform view synthesis of wide-baseline panoramas.

Example implementations can generate a video by synthesizing wide-baseline panoramas to fill in visual gaps between panoramic image in a sequence of panoramic images. The resultant video can be streamed, as a 360-degree video, to computing devices (e.g., an augmented reality (AR) device) for an interactive and seamless user experience. Alternatively, example implementations can stream wide-baseline panoramas to consumer devices configured to synthesize 360-degree videos between wide-baseline panoramas and display the resultant 360-degree videos on the consumer devices for an interactive and seamless experience. Unlike existing systems which only synthesize novel views within a limited volume or along a trajectory in rectilinear projection, example implementations can generate 360-degree video that can enable (or help enable) users to move forward/backward, stop at any point, and look around from any perspective. This unlocks a wide range of applications (e.g., virtual reality applications) such as cinematography, teleconferencing, and virtual tourism, and/or the like. Therefore, view synthesis of wide-baseline panoramas can improve the functionality of platforms that can allow users to virtually walk through a city, preview a floorplan, and/or the like (e.g., indoor environments and outdoor environments). View synthesis of wide-baseline panoramas can enable a full field-of-view (e.g., a 360-degree view) by enabling alignment between two panoramas.

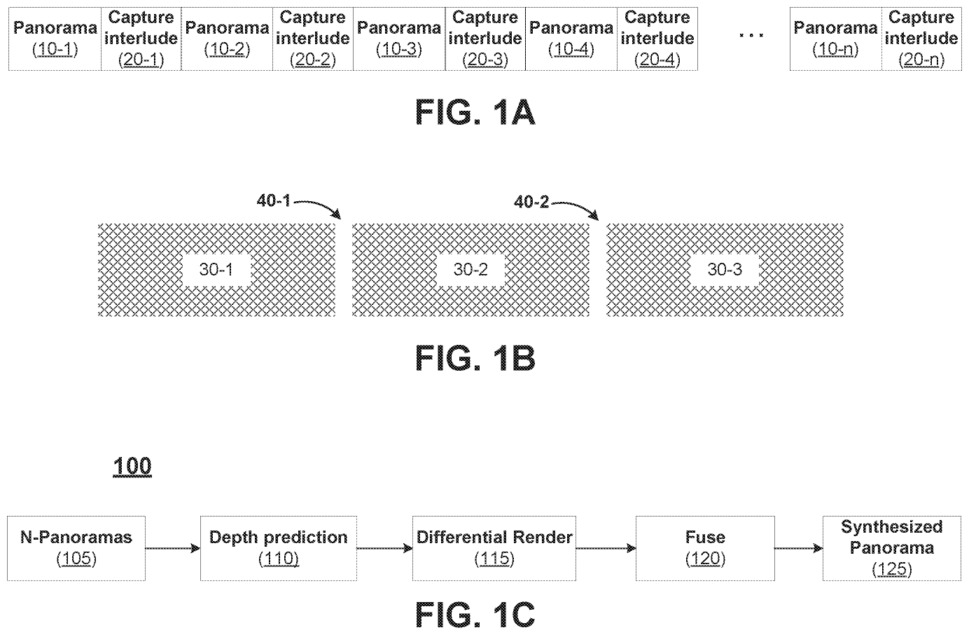

FIG. 1A illustrates a panoramic image capture sequence. As shown in FIG. 1A, a plurality of panoramas 10-1, 10-2, 10-3, 10-4, . . . , 10-n (e.g., wide-baseline panoramas or wide-baseline panoramic images) can be captured as images in an image sequence. After a panoramic image is captured, a capture interlude 20-1, 20-2, 20-3, 20-4, . . . , 20-n can exist. The capture interlude 20-1, 20-2, 20-3, 20-4, . . . , 20-n (or a capture time interval) can be caused by a time during which a camera (e.g., 360-degree camera) is not capturing an image. In other words, the camera can be capturing a sequence of images which is not capturing a video because the camera is not continually capturing data (as in a video). Therefore, there are periods in which there are delays (e.g., time and distance) between capturing images illustrated as the capture interludes 20-1, 20-2, 20-3, 20-4, and 20-n. In some implementations, the capture interlude 20-1, 20-2, 20-3, 20-4, . . . , 20-n can cause a distance gap, corresponding to the capture interlude, of at least five (5) meters. A graphical result of the capture interlude 20-1, 20-2, 20-3, 20-4, . . . , 20-n can be illustrated by FIG. 1B.

FIG. 1B illustrates a portion of a 360-degree video based on the captured panoramic images. As shown in FIG. 1B, a plurality of panoramas 30-1, 30-2, 30-3, 30-4, 30-5, 30-6, 30-7, 30-8, 30-9 (e.g., wide-baseline panoramas or wide-baseline panoramic images) can be used to generate a portion of a 360-degree video. The portion of a 360-degree video can be generated based on a 3D position (e.g., x, y, z) within a corresponding location (e.g., a geographic location, a room, and/or the like) using, for example, a global positioning system (GPS), a location anchor, and/or the like. As shown in FIG. 1B, there are gaps 40-1. 40-2 (e.g., distance) between two or more of the panoramas 30-1, 30-2, 30-3. The gaps 40-1. 40-2 can be based on the capture interludes 20-1, 20-2, 20-3, 20-4, . . . , 20-n. The gaps 40-1, 40-2 are shown as being smaller than the panoramas 30-1, 30-2, 30-3, however, the gaps 40-1, 40-2 can be smaller, larger, the same size the panoramas 30-1, 30-2, 30-3. In other words, the gaps 40-1, 40-2 can be any size in relation to the panoramas 30-1, 30-2, 30-3. Although the gaps 40-1, 40-2 are shown in a horizontal (e.g., horizontal direction) sequence, gaps can also be in a vertical (e.g., vertical direction) sequence and/or a diagonal (diagonal direction) sequence. The gaps 40-1, 40-2 can be detrimental to a user experience while viewing a 360-degree video. Therefore, example implementations, as briefly described with regard to FIG. 1C, can include a technique used to reduce or eliminate gaps 40-1. 40-2, 50-1, 50-2 that can be caused by the capture interlude 20-1, 20-2, 20-3, 20-4, . . . , 20-n.

FIG. 1C illustrates a block diagram of a panoramic image synthesis flow according to an example embodiment. As shown in FIG. 1C an image synthesis flow 100 includes n-panoramas 105, a depth prediction 110 block, a differential render 115 block, a fuse 120 block, and a synthesized panorama 125.

The n-panoramas 105 can be a sequence of n panoramic images captured by a rotating camera. The n-panoramas 105 each can be a two-dimensional (2D) projection of a partial (e.g., 180-degree) three-dimensional (3D) view captured with a 360-degree rotation (e.g., camera rotation).

The depth prediction 110 block be configured to predict a depth associated with each of the n-panoramas 105. The depth can be based on two adjacent panoramas in the sequence of n-panoramas 105. The differential render 115 block can be configured to generate an RGB panorama and/or an RGBD panorama based on the depth prediction and a viewpoint corresponding to a target position. The target position can be a differential position based on the position associated with the panorama. The target position can be associated with one or more of the gaps 40-1. 40-2, 50-1, 50-2 that can be caused by the capture interlude 20-1, 20-2, 20-3, 20-4, . . . , 20-n.

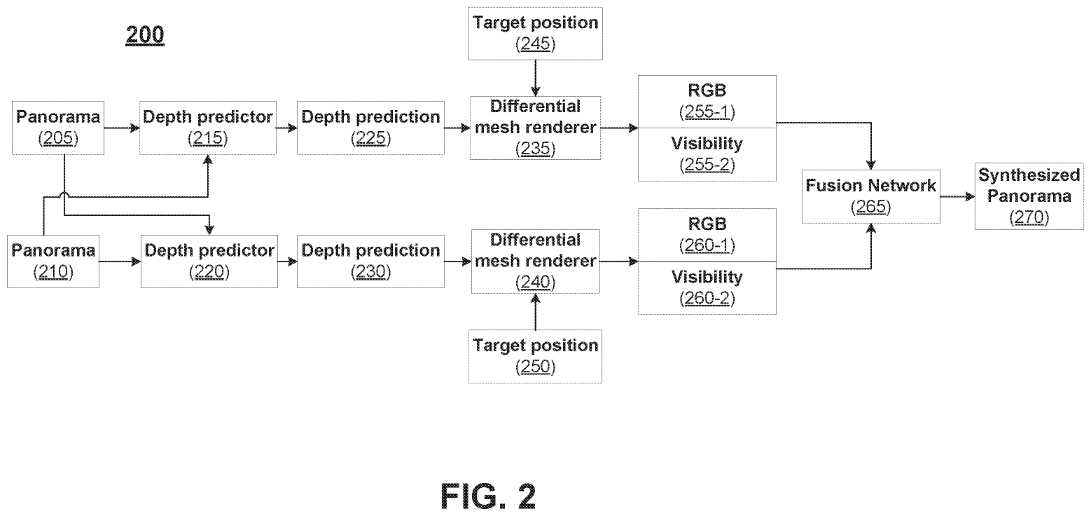

The fuse 120 block can be configured to generate the synthesized panorama 125 based on at least two differentially rendered panoramas. The synthesized panorama 125 can be inserted into the sequence of images including the n-panoramas 105 in between two of the n-panoramas 105. A more detailed description for generating a synthesized panorama is described with regard to FIG. 2.

FIG. 2 illustrates a block diagram of a panoramic image synthesis flow according to an example embodiment. As shown in FIG. 2, a panoramic image synthesis flow 200 includes a panorama 205, 210, a depth predictor 215, 220, a depth prediction 225, 230 block, a differential mesh renderer 235, 240, a target position 245, 250 block, an RGB 255-1, 260-1 block, a visibility 255-2, 260-2 block, a fusion network 265, and a synthesized panorama 270.

The panorama 205, 210 can be an image captured by a rotating camera. The panorama 205, 210 can be captured using a fisheye lens. Therefore, the panorama 205, 210 can be a 2D projection of a partial (e.g., 180-degree) 3D view captured with a 360-degree rotation (e.g., camera rotation). The panorama 205, 210 can include global and local alignment information. The global and local alignment information can include location (e.g., coordinates), displacement, pose information, pitch, roll, yaw (e.g., position relative to an x, y, z axis), and/or other information used to align two or more panoramas. The location can be a global positioning system (GPS), a location anchor (e.g., within a room), and/or the like. The panorama 205, 210 can be wide-baseline panoramas. A wide-baseline panorama can be where acquisition properties of two or more images significantly change. In example implementations. The significant change can be based on the position of the acquisition camera. In other words, the camera is moving at a rate that causes a gap between images. The panorama 205, 210 can be stored (or received, input, and/or the like) as a mesh.

The depth predictor 215, 220 can be configured to determine a depth associated with each pixel in the panorama 205, 210. As is shown, the depth predictor 215, 220 can determine depth using both panorama 205 and panorama 210. The depth predictor 215, 220 can use a machine learned model to determine the depth of each panorama 205, 210. The depth predictor 215, 220 can generate the depth prediction 225, 230. The depth prediction 225, 230 can be a stereo depth estimation with monocular connection(s). The stereo depth estimation can enable the matching of features presented in two or more the 360-degree images (e.g., panorama 205, 210) for aligned depth estimation. The monocular connection(s) can enable the prediction of depth for regions occluded in a first image that may or may not be occluded in a second image. The depth predictor 215, 220 is described in more detail below.

The differential mesh renderer 235, 240 can be configured to generate the RGB 255-1, 260-1 and the visibility 255-2, 260-2 based on the depth prediction 225, 230 and the target position 245, 250. Each image can be rendered from the viewpoint corresponding to the target position 245, 250. The target position 245, 250 can be a differential position based on the position associated with the panorama 205, 210. The target position 245, 250 can be associated with one or more gaps in a sequence of images (e.g., the gaps 40-1. 40-2, 50-1, 50-2) that can be caused by an image capture interlude (or a capture time interval) (e.g., capture interlude 20-1, 20-2, 20-3, 20-4, . . . , 20-n). The differential mesh renderer 235, 240 can be configured to generate a spherical mesh for each of panorama 205, 210. A mesh representation of the panorama 205, 210 can be used rather than a point cloud representation, because density issues associated with creating point clouds from ERP images can be avoided. For example, when moving large distances, point clouds created from ERP images can contain widely varying levels of sparsity which can be difficult to in-paint (e.g., filling in holes of arbitrary topology so that the addition appears to be part of the original image).

For a W×H resolution output image, the differential mesh renderer 235, 240 can be configured to generate a spherical mesh following a UV pattern with 2H height segments and 2 W width segments. Next, vertices can be offset to the correct radius based on a Euclidean depth d from the depth prediction 225, 230. After creating the mesh and offsetting vertices to their correct depth, the differential mesh renderer 235, 240 can be configured to calculate the gradient of the depth map along the θ and ϕ directions, yielding gradient images dθ and dϕ. These gradient images can represent an estimate of the normal of each surface. Large gradients in the depth image correspond to edges of buildings and other structures within the RGB image. These surfaces can have a normal vector perpendicular to the vector from the camera position. The differential mesh renderer 235, 240 can be configured to threshold the depth gradients along both directions to identify discontinuities in the 3D structure where (dθ>k)|(dϕ>k). For these areas, the differential mesh renderer 235, 240 can be configured to discard triangles within the spherical mesh to accurately represent the underlying discontinuity.

With the meshes created and discontinuities calculated, the differential mesh renderer 235, 240 can be configured to render the mesh from the new viewpoint to the RGB 255-1, 260-1 (e.g., a 360-degree RGBD image). The mesh renderings can contain holes due to occlusions in the original images. These holes can be represented in the depth image as negative values. The differential mesh renderer 235, 240 can be configured to extract and the visibility 255-2, 260-2 from the negative values.

In an example implementation, the differential mesh renderer 235, 240 can be configured to adapt a mesh renderer (e.g., a built-in mesh renderer) to output 360-degree images. For example, a rasterizer can be modified to project vertices from world-coordinates to camera-coordinates and then to screen coordinates. Rather than multiplying vertex camera-coordinates by a projection matrix, the differential mesh renderer 235, 240 can be configured to apply a Cartesian to spherical coordinates transformation and normalize the final coordinates to, for example, [−1;1].

In an example implementation, the differential mesh renderer 235, 240 can be configured to perform two (2) render passes, one rotated by 180-degrees, and composite the passes together so that triangles which wrap around are not missing in the final render. In addition, the differential mesh renderer 235, 240 can be configured to using a dense mesh to minimize the length of each triangle in the final image. Performing two (2) render passes and using a dense mesh can minimize (or prevent) cutting off triangles that wrap around the left and right edges of the panorama 205, 210 and incorrectly mapping straight lines in Cartesian coordinates to straight lines in ERP image coordinates. Performing two (2) render passes and using a dense mesh can simultaneously performed by rendering the six (6) perspective sides of a cubemap and project the cubemap into an equirectangular projection image.

The fusion network 265 can be configured to generate the synthesized panorama 270. The fusion network 265 can be configured to fuse RGB 255-1 with RGB 260-1. RGB 255-1, 260-1 can include holes due to occlusions in the synthesized view (e.g., RGB 255-1, 260-1 are synthesized at the target position 245, 250). Therefore, the fusion network 265 can be configured to in-paint the holes.

The fusion network 265 can be configured to generate the synthesized panorama 270 (e.g., a single consistent panorama) using a trained model (e.g., a trained neural network). The trained neural network can include seven (7) down-sampling elements and seven (7) up-sampling elements. In an example implementation, the fusion network 265 can be configured to generate a binary visibility mask to identify holes in each of RGB 255-1, 260-1 based on the visibility 255-2, 260-2 (e.g., the negative regions in the mesh rendering depth image). The fusion network 265 can be configured to use circular padding at each convolutional layer, simulating Circular convolutional neural network (CNNs) to join the left and right edges. The top and bottom of each feature map can use zero padding.

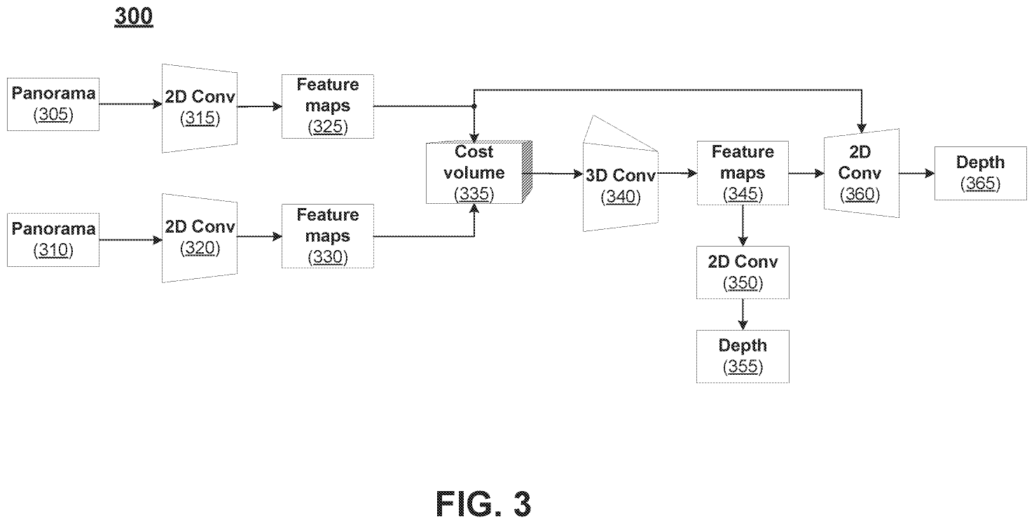

The aforementioned depth pipeline can use a neural network (e.g., CNN) with five (5) down-sampling blocks and three (3) up-sampling blocks as a feature encoder, a 3D neural network (e.g., CNN) with three (3) down-sampling and three (3) up-sampling blocks as a cost volume refinement network, and two (2) convolutional blocks as a depth decoder. The depth pipeline can use a vertical input index as an additional channel for each convolutional layer. This can enable the convolutional layers to learn the distortion associated with an equirectangular projection (ERP). The depth pipeline is discussed in more detail with regard to FIG. 3.

FIG. 3 illustrates a block diagram of a flow for predicting depth according to an example embodiment. As shown in FIG. 3, a predicting depth flow 300 (e.g., associated with the depth predictor 215, 220) includes a panorama 305, 310, a 2D convolution 315, 320, 350, 360 block, a feature maps 325, 330, 345 block, a cost volume 335 block, a 3D convolution 340 block, and a depth 355, 365 block.

The panorama 305, 310 can be an image captured by a rotating camera. The panorama 305, 310 can be captured using a fisheye lens. Therefore, the panorama 305, 310 can be a 2D projection of a partial (e.g., 180-degree) 3D view captured with a 360-degree rotation (e.g., camera rotation). The panorama 305, 310 can include global and local alignment information. The global and local alignment information can include location (e.g., coordinates), displacement, pose information, pitch, roll, yaw (e.g., position relative to an x, y, z axis), and/or other information used to align two or more panoramas. The location can be a global positioning system (GPS), a location anchor (e.g., within a room), and/or the like. The panorama 305, 310 can be wide-baseline panoramas. A wide-baseline panorama can be where acquisition properties of two or more images significantly change. In example implementations. The significant change can be based on the position of the acquisition camera. In other words, the camera is moving at a rate that causes a gap between images. The panorama 305, 310 can be stored (or received, input, and/or the like) as a mesh.

The 2D convolution 315, 320 block can be configured to generate features associated with the panorama 305, 310. The 2D convolution 315, 320 block can be a trained neural network (e.g., CNN). The 2D convolution 315, 320 block can be a contracting path (e.g., encoder) associated with convolutional model (the 2D convolution 350, 360 being an expansive path (e.g., decoder)). The 2D convolution 315, 320 can be a classification network (e.g., like VGG/ResNet) with convolution blocks followed by a maxpool down-sampling applied to encode the panorama 305, 310 into feature representations at multiple different levels. The feature representations at multiple different levels can be the feature maps 325, 330.

The cost volume 335 block can be configured to generate a spherical sweep cost volume of features based on the feature maps 325, 330. A cost volume can be a measure of similarities between all pairs of reference and matching candidate points in the feature maps 325, 330. A spherical sweep can be configured to align feature maps 325 with feature maps 330. A spherical sweep can include transforming the feature maps 325, 330 into a spherical domain. Transforming the feature maps 325, 330 can include projecting the feature maps 325, 330 onto a predefined sphere. Generating a spherical sweep cost volume of features can include merging the spherical volumes associated with the feature maps 325, 330 and using the merged spherical volumes as input to a cost function (e.g., sum of absolute differences (SAD), sum of squared differences (SSD), normalized cross-correlation (NCC), zero-mean based costs (like ZSAD, ZSSD and ZNCC), costs computed on the first (gradient) or second (Laplacian of gaussian) image derivatives, and/or the like) for stereo matching (e.g., matching a patch from the panorama 305, centered at position p, with a patch from the panorama 310, centered at position p-d).

The 3D convolution 340 block can be configured to refine the cost volume. Refining the cost volume can include aggregating the feature information along a disparity dimension spatial dimension(s). The 3D convolution 340 can be a 3D neural network (e.g., CNN). The 3D neural network can include three (3) down-sampling and three (3) up-sampling blocks as a cost volume refinement network. Refining the cost volume can generate feature maps. The feature maps can be the feature maps 345.

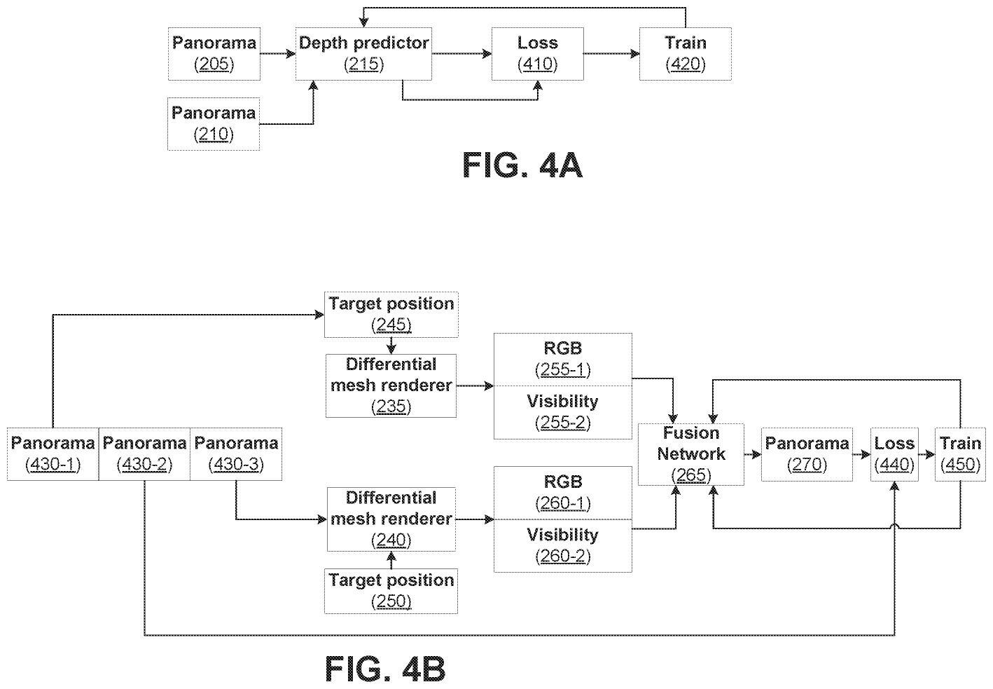

The feature maps 345 can be input to the 2D convolution 350 block and the 2D convolution 360 block. The 2D convolution 350, 360 block can be used as a depth decoder (e.g., depth prediction) to generate (e.g., predict) the depth 355, 365 block. Depth decoding can include using two (2) convolutional blocks. The feature maps 345 can be input to the 2D convolution 360 block. Feature maps 325 can be used as a vertical input index as an additional channel for each convolutional layer in the depth prediction network. This can allow the convolutional layers to learn the distortion associated with the equirectangular projection (ERP). The depth prediction described with regard to FIG. 3 can be trained. For example, the depth prediction can be associated with the depth predictor 215, 220. The training of the neural networks associated with depth prediction is described with regard to FIG. 4A.

FIG. 4A illustrates a block diagram of a flow for training a model for predicting depth according to an example embodiment. As shown in FIG. 4A, training a model for predicting depth includes the panorama 205, 210, the depth predictor 215, 220, the depth prediction 225, 230 block, a loss 410 block, and a training 420 block.

The depth predictor 215 uses two panorama 205, 210 (e.g., wide-baseline images in a sequence) as input for training. The depth predictor 215 includes two outputs (e.g., depth 355 and depth 365), a first output (e.g., depth 355) which includes a prediction of a low-resolution depth d_{pred_low} based on only the cost volume (e.g., cost volume 335) and a second output (e.g., depth 365) which includes a prediction of a higher resolution depth d_{pred_hi} from the feature map (e.g., feature maps 325) and the cost volume (e.g., cost volume 335). The first output can be associated with a gradient flow. In an example implementation, loss function for depth associated with loss 410 block can be:

$${l}_{depth} = {‖ \frac{1}{{d}_{gt}} - \frac{1}{{d}_{pred \_ hi}} ‖}_{1} + λ {‖ \frac{1}{{d}_{gt}} - \frac{1}{{d}_{pred \_ low}} ‖}_{1} ,$$

where:
   l_{depth} is the depth loss,
   d_{gt} is a depth gradient threshold,
   λ is a scaling factor (e.g., λ=0.5),
   d_{pred_hi} is the higher resolution depth, and
   d_{pred_low} is the low-resolution depth.

The training 420 block can be configured to cause the training of the depth predictor 215. In an example implementation, the depth predictor 215 includes the 2D convolution 315, 320, 350, 360 block and the 3D convolution 340 block each having weights associated with the convolutions. Training the depth predictor 215 can include modifying these weights. Modifying the weights can cause the two outputs (e.g., depth 355 and depth 365) to change (e.g., change even with the same input panoramas). Changes in the two outputs (e.g., depth 355 and depth 365) can impact depth loss (e.g., loss 410). Training iterations can continue until the loss 410 is minimized and/or until the loss 410 does not change significantly from iteration to iteration.

FIG. 4B illustrates a block diagram of a flow for training a model for panoramic image fusion according to an example embodiment. As shown in FIG. 4B, training a model for panoramic image fusion includes a panorama 430-1, 430-2, 430-3, the target position 245, 250 block, the RGB 255-1, 260-1 block, the visibility 255-2, 260-2 block, the fusion network 265, the synthesized panorama 270, a loss 440 block, and a training 450 block.

Training the fusion network 265 includes using a sequences of three (3) panoramas (panorama 430-1, 430-2, 430-3). Mesh renders can be generated from the first and last panoramas (panorama 430-1, 430-3) using the pose of the intermediate panorama (panorama 430-2). The fusion network 265 can receive the mesh renders and combine the mesh renders to predict an intermediate panorama (e.g., panorama 270). The ground-truth intermediate panorama (panorama 430-2) is used for supervision. The loss 440 can be used to train the fusion network 265. The loss 440 can be determined as:

$${l}_{fusion} = {‖ {p}_{1} - {p}_{pred} ‖}_{1} ,$$

where:
   I_{fusion} is the fusion loss (e.g., loss 440),
   p_{I} is the ground truth panorama (e.g., panorama 430-2), and
   p_{pred} is the predicted panorama (panorama 270).

The training 450 block can be configured to cause the training of the fusion network 265. Training of the fusion network 265 can include modifying weights associated with at least one of convolution the fusion network 265. In an example implementation, fusion network 265 can be trained based on a difference between a predicted panorama (e.g., panorama 270) and a ground truth panorama (e.g., panorama 430-2). A loss (e.g., loss 440) can be generated based on the difference between the predicted panorama and the ground truth panorama. Training iterations can continue until the loss 440 is minimized and/or until the loss 440 does not change significantly from iteration to iteration. In an example implementation, the lower the loss, the better the fusion network 265 is at synthesizing (e.g., predicting) an intermediate panorama. In addition, if the depth predictor 215 and the fusion network 265 are trained together, a total loss can be lₜₒₜₐₗ=l_{depth}+l_{fusion}.

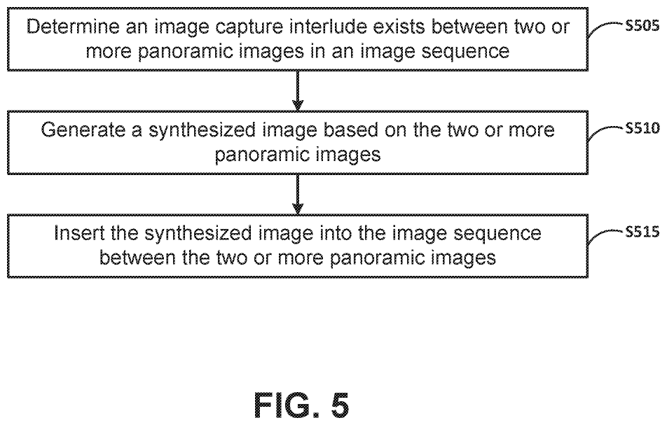

FIG. 5 illustrates a block diagram of a method for generating a panoramic image sequence according to an example embodiment. As shown in FIG. 5, in step S505 an image capture interlude (or a capture time interval) is determined to exist between two or more panoramic images in an image sequence. For example, an image sequence or panoramic image sequence can be captured by a rotating camera. Each panoramic image in the image sequence can be a 2D projection of a partial (e.g., 180-degree) 3D view captured with a 360-degree rotation (e.g., camera rotation). A capture interlude (or a capture time interval) can be caused by a time during which a camera (e.g., 360-degree camera) is not capturing an image. In other words, the camera can be capturing a sequence of images which is not capturing a video because the camera is not continually capturing data (as in a video). Therefore, there are periods in which there are delays (e.g., time and distance) between capturing images. In some implementations, the capture interlude can cause a distance gap (between images of at least five (5) meters.

In step S510 a synthesized image is generated based on the two or more panoramic images. For example, if an image capture interlude (or a capture time interval) exists, example implementations can synthesize at least one panoramic image to insert into the sequence of images in order to reduce and/or eliminate the distance gap between two panoramic images. In step S515 the synthesized image is inserted into the image sequence between the two or more panoramic images. For example, referring to FIG. 1B, the synthesized can be inserted to minimize and/or eliminate one or more of gaps 40-1. 40-2, 50-1, 50-2.

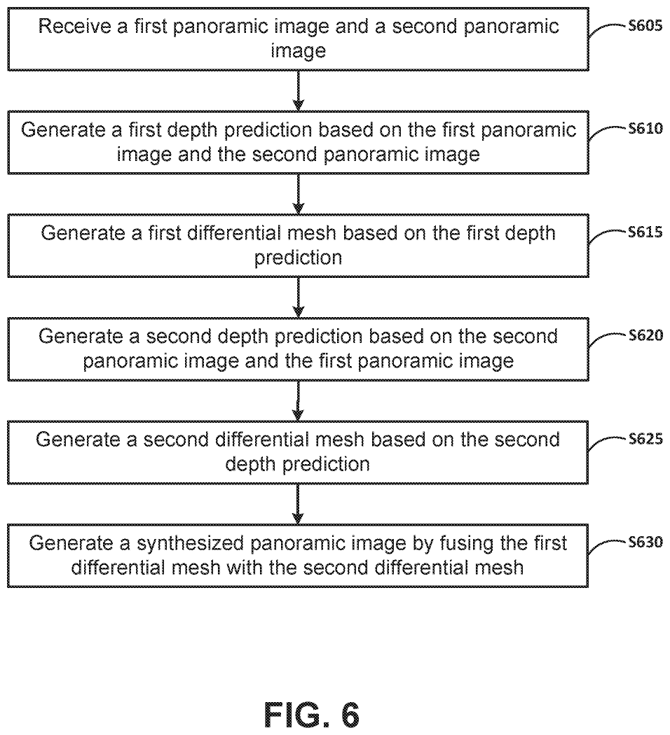

FIG. 6 illustrates a block diagram of a method for synthesizing a panoramic image according to an example embodiment. As shown in FIG. 6, in step S605 a first panoramic image and a second panoramic image are received. For example, the panoramas (panorama 205, 210) can be images captured by a rotating camera. The panoramas can be captured using a fisheye lens. Therefore, the panoramas can be a 2D projection of a partial (e.g., 180-degree) 3D view captured with a 360-degree rotation (e.g., camera rotation). The panoramas can include global and local alignment information. The global and local alignment information can include location (e.g., coordinates), displacement, pose information, pitch, roll, yaw (e.g., position relative to an x, y, z axis), and/or other information used to align two or more panoramas. The location can be a global positioning system (GPS), a location anchor (e.g., within a room), and/or the like. The panoramas can be wide-baseline panoramas. A wide-baseline panorama can be where acquisition properties of two or more images significantly change. In example implementations. The significant change can be based on the position of the acquisition camera. In other words, the camera is moving at a rate that causes a gap between images. The panoramas can be stored (or received, input, and/or the like) as a mesh.

In step S610 a first depth prediction is generated based on the first panoramic image and the second panoramic image. For example, the first depth prediction can include determining a depth associated with each pixel in the first panorama. The first depth prediction can be based on both the first panorama and the second panorama. The first depth prediction can use a machine learned model to determine the depth of the panorama(s). The depth prediction can be a stereo depth estimation with monocular connection(s). The stereo depth estimation can enable the matching of features presented in two or more 360-degree images (e.g., panorama 205, 210) for aligned depth estimation. The monocular connection(s) can enable the prediction of depth for regions occluded in the first panoramic image that may or may not be occluded in the second panoramic image.

In step S615 a first differential mesh is generated based on the first depth prediction. For example, a differential mesh renderer (e.g., differential mesh renderer 235) can generate an RGB-D image (e.g., RGB 255-1 and a visibility map (e.g., visibility 255-2) based on the first depth prediction (e.g., depth prediction 225) and a target position (e.g., target position 245). Each image can be rendered from the viewpoint corresponding to the target position. The target position can be a differential position based on the position associated with the first panorama and the second panorama. The first differential mesh can be a spherical mesh corresponding to the first panorama. A mesh representation of the first panorama can be used rather than a point cloud representation, because density issues associated with creating point clouds from ERP images can be avoided. For example, when moving large distances, point clouds created from ERP images can contain widely varying levels of sparsity which can be difficult to in-paint (e.g., filling in holes of arbitrary topology so that the addition appears to be part of the original image).

In step S620 a second depth prediction is generated based on the second panoramic image and the first panoramic image. For example, the second depth prediction can include determining a depth associated with each pixel in the second panorama. The second depth prediction can be based on both the first panorama and the second panorama. The second depth prediction can use a machine learned model to determine the depth of the panorama(s). The depth prediction can be a stereo depth estimation with monocular connection(s). The stereo depth estimation can enable the matching of features presented in two or more 360-degree images (e.g., panorama 205, 210) for aligned depth estimation. The monocular connection(s) can enable the prediction of depth for regions occluded in the second panoramic image that may or may not be occluded in the first panoramic image.

In step S625 a second differential mesh is generated based on the second depth prediction. For example, a differential mesh renderer (e.g., differential mesh renderer 235) can generate an RGB-D image (e.g., RGB 260-1 and a visibility map (e.g., visibility 260-2) based on the second depth prediction (e.g., depth prediction 230) and a target position (e.g., target position 250). Each image can be rendered from the viewpoint corresponding to the target position. The target position can be a differential position based on the position associated with the first panorama and the second panorama. The first differential mesh can be a spherical mesh corresponding to the second panorama. A mesh representation of the second panorama can be used rather than a point cloud representation, because density issues associated with creating point clouds from ERP images can be avoided. For example, when moving large distances, point clouds created from ERP images can contain widely varying levels of sparsity which can be difficult to in-paint (e.g., filling in holes of arbitrary topology so that the addition appears to be part of the original image).

In step S630 a synthesized panoramic image is generated by fusing the first differential mesh with the second differential mesh. For example, a fusion network (e.g., fusion network 265) can fuse an RGB-D image associated with the first differential mesh and an RGB-D image associated with the second differential mesh (e.g., RGB 255-1 with RGB 260-1). The RGB-D(s) can include holes due to occlusions in the synthesized view are synthesized at the target position 245, 250. Therefore, the fusion can include in-painting the holes. The fusion can generate the synthesized panorama using a trained model (e.g., a trained neural network). The trained neural network can include seven (7) down-sampling elements and seven (7) up-sampling elements. In an example implementation, the fusion can include generating a binary visibility mask to identify holes (e.g., the negative regions in the mesh rendering depth image) in each of RGB-D based on a visibility map (e.g., visibility 255-2, 260-2). The fusion can include using circular padding at each convolutional layer, simulating Circular convolutional neural networked (CNNs) to join the left and right edges. The top and bottom of each feature map can use zero padding.

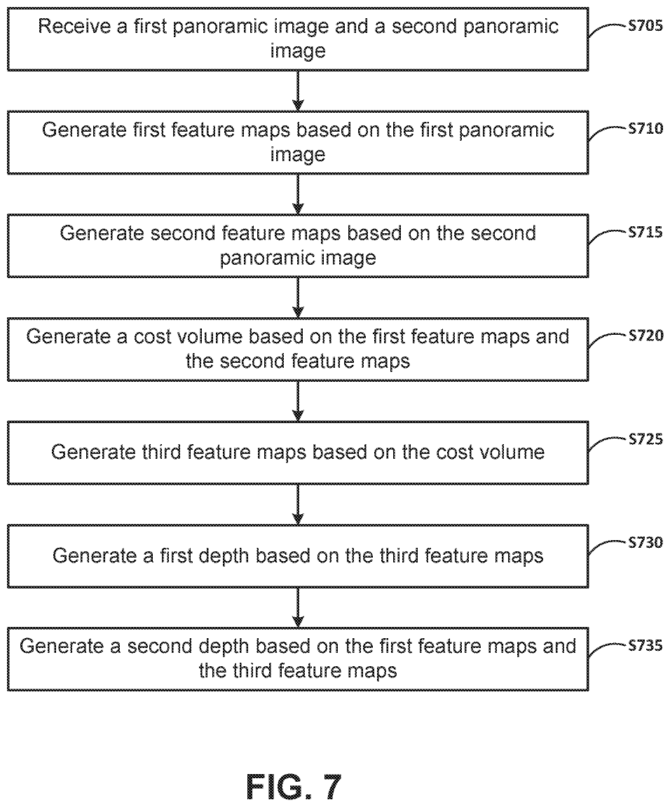

FIG. 7 illustrates a block diagram of a method for predicting depth according to an example embodiment. As shown in FIG. 7, in step S705 a first panoramic image and a second panoramic image are received. For example, the panoramas (panorama 205, 210) can be images captured by a rotating camera. The panoramas can be captured using a fisheye lens. Therefore, the panoramas can be a 2D projection of a partial (e.g., 180-degree) 3D view captured with a 360-degree rotation (e.g., camera rotation). The panoramas can include global and local alignment information. The global and local alignment information can include location (e.g., coordinates), displacement, pose information, pitch, roll, yaw (e.g., position relative to an x, y, z axis), and/or other information used to align two or more panoramas. The location can be a global positioning system (GPS), a location anchor (e.g., within a room), and/or the like. The panoramas can be wide-baseline panoramas. A wide-baseline panorama can be where acquisition properties of two or more images significantly change. In example implementations. The significant change can be based on the position of the acquisition camera. In other words, the camera is moving at a rate that causes a gap between images. The panoramas can be stored (or received, input, and/or the like) as a mesh.

In step S710 first maps are generated based on the first panoramic image. For example, a neural network can be used to generate features associated with the first panorama. In an example implementation, a 2D convolution can be a trained neural network (e.g., CNN). The 2D convolution can be a contracting path (e.g., encoder) associated with a convolutional model. The 2D convolution can be a classification network (e.g., like VGG/ResNet) with convolution blocks followed by a maxpool down-sampling applied to encode the first panorama into feature representations at multiple different levels. The feature representations at multiple different levels can be the first feature maps.

In step S715 second feature maps are generated based on the second panoramic image. For example, a neural network can be used to generate features associated with the second panorama. In an example implementation, a 2D convolution can be a trained neural network (e.g., CNN). The 2D convolution can be a contracting path (e.g., encoder) associated with a convolutional model. The 2D convolution can be a classification network (e.g., like VGG/ResNet) with convolution blocks followed by a maxpool down-sampling applied to encode the second panorama into feature representations at multiple different levels. The feature representations at multiple different levels can be the second feature maps.

In step S720 a cost volume is generated based on the first feature maps and the second feature maps. For example, a spherical sweep cost volume of features based on the first feature maps and the second feature maps (e.g., feature maps 325, 330) can be determined (or generated). A cost volume can be a measure of similarities between all pairs of reference and matching candidate points in the feature maps. A spherical sweep can be configured to align the first feature maps with the second feature maps. A spherical sweep can include transforming the feature maps into a spherical domain. Transforming the feature maps can include projecting the feature maps onto a predefined sphere. Generating a spherical sweep cost volume of features can include merging the spherical volumes associated with the feature maps and using the merged spherical volumes as input to a cost function (e.g., sum of absolute differences (SAD), sum of squared differences (SSD), normalized cross-correlation (NCC), zero-mean based costs (like ZSAD, ZSSD and ZNCC), costs computed on the first (gradient) or second (Laplacian of gaussian) image derivatives, and/or the like) for stereo matching (e.g., matching a patch from the first panorama, centered at position p, with a patch from the second panorama, centered at position p-d).

In step S725 third feature maps are generated based on the cost volume. For example, the third feature maps can be generated by refining the cost volume. Refining the cost volume can include aggregating the feature information along a disparity dimension spatial dimension(s). Refining the cost volume can include using a 3D convolutional neural network (e.g., CNN). The 3D neural network can include three (3) down-sampling and three (3) up-sampling blocks as a cost volume refinement network. Refining the cost volume can generate the third feature maps.

In step S730 a first depth is generated based on the third feature maps. For example, a 2D convolution can be used as a depth decoder (e.g., depth prediction) to generate (e.g., predict) the first depth. Depth decoding can include using two (2) convolutional blocks. The depth prediction can be a trained depth prediction.

In step S735 a second depth is generated based on the first feature maps and the third feature maps. For example, a 2D convolution can be used as a depth decoder (e.g., depth prediction) to generate (e.g., predict) the first depth. Depth decoding can include using two (2) convolutional blocks. The first feature maps can be input to a 2D convolution. The first feature maps can be used as a vertical input index as an additional channel for each convolutional layer in the depth prediction network. This can allow the convolutional layers to learn the distortion associated with the equirectangular projection (ERP).

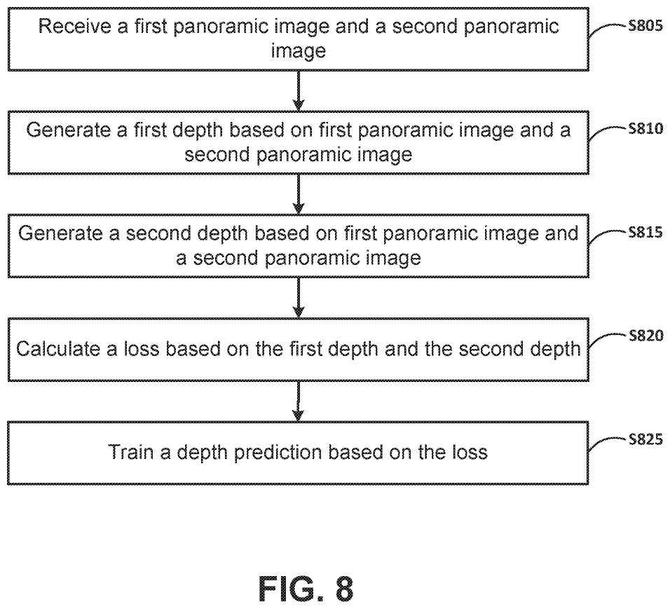

FIG. 8 illustrates a block diagram of a method for training a model for predicting depth according to an example embodiment. As shown in FIG. 8, in step S805 a first panoramic image and a second panoramic image are received. For example, the panoramas (panorama 205, 210) can be images captured by a rotating camera. The panoramas can be captured using a fisheye lens. Therefore, the panoramas can be a 2D projection of a partial (e.g., 180-degree) 3D view captured with a 360-degree rotation (e.g., camera rotation). The panoramas can include global and local alignment information. The global and local alignment information can include location (e.g., coordinates), displacement, pose information, pitch, roll, yaw (e.g., position relative to an x, y, z axis), and/or other information used to align two or more panoramas. The location can be a global positioning system (GPS), a location anchor (e.g., within a room), and/or the like. The panoramas can be wide-baseline panoramas. A wide-baseline panorama can be where acquisition properties of two or more images significantly change. In example implementations. The significant change can be based on the position of the acquisition camera. In other words, the camera is moving at a rate that causes a gap between images. The panoramas can be stored (or received, input, and/or the like) as a mesh.

In step S810 a first depth is generated based on first panoramic image and a second panoramic image. In step S815 a second depth is generated based on first panoramic image and a second panoramic image. Generating the first depth and the second depth is described above with regard to, for example, FIG. 7 steps S730 and step S735. For example, depth prediction can use two panoramas (e.g., wide-baseline images in a sequence) as input for training. The depth prediction can include two outputs (e.g., depth 355 and depth 365), a first output (e.g., depth 355) which includes a prediction of a low-resolution depth d_{pred_low} based on only the cost volume (e.g., cost volume 335) and a second output (e.g., depth 365) which includes a prediction of a higher resolution depth d_{pred_hi} from the feature map (e.g., feature maps 325) and the cost volume (e.g., cost volume 335). The first output can be associated with a gradient flow.

In step S820 a loss is calculated based on the first depth and the second depth. For example, a loss function for depth based on low-resolution depth d_{pred_low} and higher resolution depth d_{pred_hi} can be used to calculate loss as discussed above.

In step S825 a depth prediction is trained based on the loss. For example, the depth prediction can include use of at least one 2D convolution and at least one 3D convolution each having weights associated with the convolutions. Training the depth prediction can include modifying these weights. Modifying the weights can cause the two outputs (e.g., depth 355 and depth 365) to change (e.g., change even with the same input panoramas). Changes in the two outputs (e.g., depth 355 and depth 365) can impact depth loss (e.g., loss 410). Training iterations can continue until the loss is minimized and/or until the loss does not change significantly from iteration to iteration.

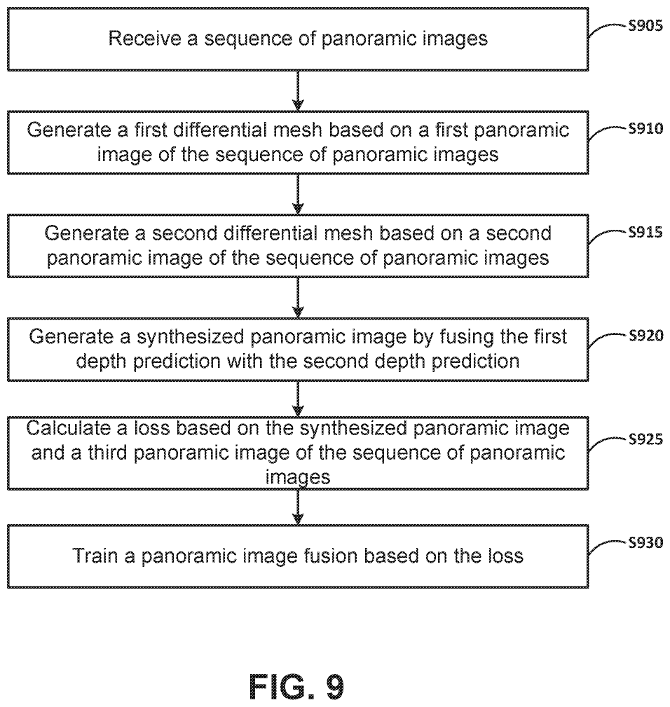

FIG. 9 illustrates a block diagram of a method for training a model for panoramic image fusion according to an example embodiment. As shown in FIG. 9, in step S905 a sequence of panoramic images is received. For example, the panoramas (e.g., panorama 430-1, 430-2, 430-3) can be images captured by a rotating camera. The panoramas can be captured using a fisheye lens. Therefore, the panoramas can be a 2D projection of a partial (e.g., 180-degree) 3D view captured with a 360-degree rotation (e.g., camera rotation). The panoramas can include global and local alignment information. The global and local alignment information can include location (e.g., coordinates), displacement, pose information, pitch, roll, yaw (e.g., position relative to an x, y, z axis), and/or other information used to align two or more panoramas. The location can be a global positioning system (GPS), a location anchor (e.g., within a room), and/or the like. The panoramas can be wide-baseline panoramas. A wide-baseline panorama can be where acquisition properties of two or more images significantly change. In example implementations. The significant change can be based on the position of the acquisition camera. In other words, the camera is moving at a rate that causes a gap between images. The panoramas can be stored (or received, input, and/or the like) as a mesh.

In step S910 a first differential mesh is generated based on a first panoramic image of the sequence of panoramic images. For example, a differential mesh renderer (e.g., differential mesh renderer 235) can generate an RGB-D image (e.g., RGB 255-1 and a visibility map (e.g., visibility 255-2) based on a depth prediction associated with the first panoramic image and a target position (e.g., target position 245). Each image can be rendered from the viewpoint corresponding to the target position. The target position can be a differential position based on the position associated with the first panorama and the second panorama. The first differential mesh can be a spherical mesh corresponding to the first panorama. A mesh representation of the first panorama can be used rather than a point cloud representation, because density issues associated with creating point clouds from ERP images can be avoided. For example, when moving large distances, point clouds created from ERP images can contain widely varying levels of sparsity which can be difficult to in-paint (e.g., filling in holes of arbitrary topology so that the addition appears to be part of the original image).

In step S915 a second differential mesh is generated based on a second panoramic image of the sequence of panoramic images. For example, a differential mesh renderer (e.g., differential mesh renderer 240) can generate an RGB-D image (e.g., RGB 260-1 and a visibility map (e.g., visibility 260-2) based on a depth prediction associated with the second panoramic image and a target position (e.g., target position 245). Each image can be rendered from the viewpoint corresponding to the target position. The target position can be a differential position based on the position associated with the first panorama and the second panorama. The first differential mesh can be a spherical mesh corresponding to the first panorama. A mesh representation of the first panorama can be used rather than a point cloud representation, because density issues associated with creating point clouds from ERP images can be avoided. For example, when moving large distances, point clouds created from ERP images can contain widely varying levels of sparsity which can be difficult to in-paint (e.g., filling in holes of arbitrary topology so that the addition appears to be part of the original image).

In step S920 a synthesized panoramic image is generated by fusing the first depth prediction with the second depth prediction. For example, a fusion network (e.g., fusion network 265) can fuse an RGB-D image associated with the first differential mesh and an RGB-D image associated with the second differential mesh (e.g., RGB 255-1 with RGB 260-1). The RGB-D(s) can include holes due to occlusions in the synthesized view are synthesized at the target position 245, 250. Therefore, the fusion can include in-painting the holes. The fusion can generate the synthesized panorama using a trained model (e.g., a trained neural network). The trained neural network can include seven (7) down-sampling elements and seven (7) up-sampling elements. In an example implementation, the fusion can include generating a binary visibility mask to identify holes (e.g., the negative regions in the mesh rendering depth image) in each of RGB-D based on a visibility map (e.g., visibility 255-2, 260-2). The fusion can include using circular padding at each convolutional layer, simulating Circular convolutional neural networked (CNNs) to join the left and right edges. The top and bottom of each feature map can use zero padding.

In step S925 a loss is calculated based on the synthesized panoramic image and a third panoramic image of the sequence of panoramic images. For example, the third panoramic image (e.g., panorama 430-2) can be sequentially in between the first panoramic image (e.g., panorama 430-1) and the second panoramic image (e.g., panorama 430-3). The loss can be calculated as described above with regard to loss 440.

Training a fusion network can include using a sequences of three (3) panoramas (e.g., panorama 430-1, 430-2, 430-3). Mesh renders can be generated from the first and last panoramas (panorama 430-1, 430-3) using the pose of the intermediate panorama (panorama 430-2). The fusion network can receive the mesh renders and combine the mesh renders to predict an intermediate panorama (e.g., panorama 270). The ground-truth intermediate panorama (e.g., panorama 430-2) can be used for supervision. The loss can be used to train the fusion network.

In step S930 a panoramic image fusion is trained based on the loss. For example, training of the fusion network can include modifying weights associated with at least one convolution associated with the fusion network. In an example implementation, fusion network can be trained based on a difference between a predicted panorama (e.g., panorama 270) and a ground truth panorama (e.g., panorama 430-2). A loss (e.g., loss 440) can be generated based on the difference between the predicted panorama and the ground truth panorama. Training iterations can continue until the loss is minimized and/or until the loss does not change significantly from iteration to iteration. In an example implementation, the lower the loss, the better the fusion network is at synthesizing (e.g., predicting) an intermediate panorama.

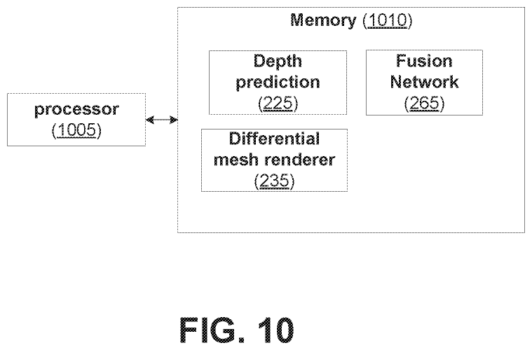

FIG. 10 illustrates a block diagram of a computing system according to at least one example embodiment. As shown in FIG. 10, the computing system includes at least one processor 1005 and at least one memory 1010. The at least one memory 1010 can include, at least, the depth prediction 225 block, the differential mesh renderer 235 and the fusion network.

In the example of FIG. 10, the computing system may be, or include, at least one computing device and should be understood to represent virtually any computing device configured to perform the techniques described herein. As such, the computing system may be understood to include various components which may be utilized to implement the techniques described herein, or different or future versions thereof. By way of example, the computing system is illustrated as including at least one processor 1005, as well as at least one memory 1010 (e.g., a non-transitory computer readable storage medium).

The at least one processor 1005 may be utilized to execute instructions stored on the at least one memory 1010. Therefore, the at least one processor 1005 can implement the various features and functions described herein, or additional or alternative features and functions. The at least one processor 1005 and the at least one memory 1010 may be utilized for various other purposes. For example, the at least one memory 1010 may represent an example of various types of memory and related hardware and software which may be used to implement any one of the modules described herein.

The at least one memory 1010 may be configured to store data and/or information associated with the computing system. The at least one memory 1010 may be a shared resource. For example, the computing system may be an element of a larger system (e.g., a server, a personal computer, a mobile device, and/or the like). Therefore, the at least one memory 1010 may be configured to store data and/or information associated with other elements (e.g., image/video serving, web browsing or wired/wireless communication) within the larger system.

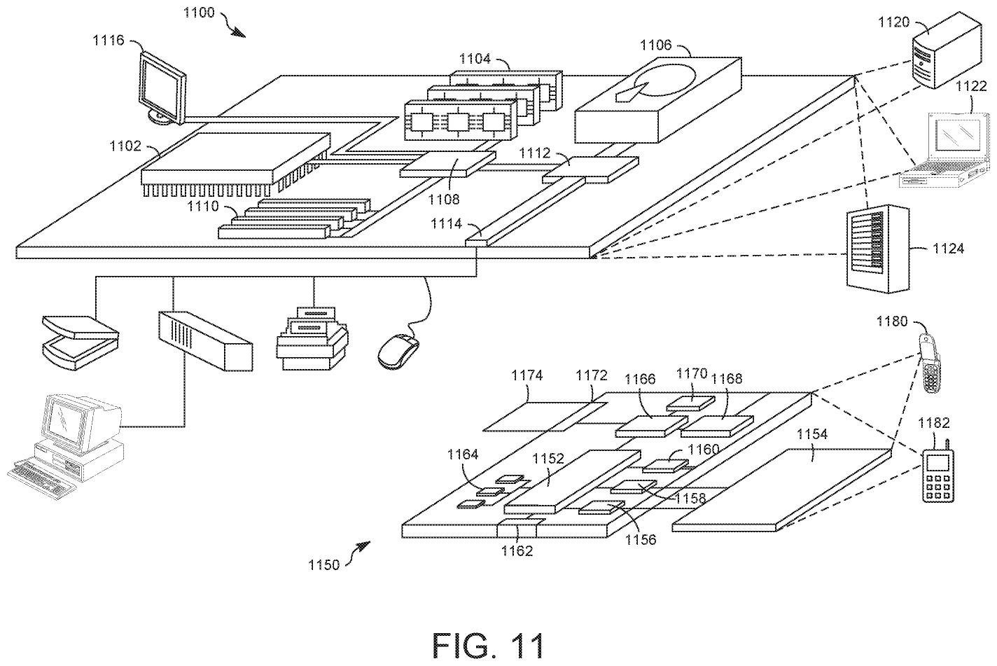

FIG. 11 shows an example of a computer device 1100 and a mobile computer device 1150, which may be used with the techniques described here. Computing device 1100 is intended to represent various forms of digital computers, such as laptops, desktops, workstations, personal digital assistants, servers, blade servers, mainframes, and other appropriate computers. Computing device 1150 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1100 includes a processor 1102, memory 1104, a storage device 1106, a high-speed interface 1108 connecting to memory 1104 and high-speed expansion ports 1110, and a low-speed interface 1112 connecting to low-speed bus 1114 and storage device 1106. Each of the components 1102, 1104, 1106, 1108, 1110, and 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as display 1116 coupled to high-speed interface 1108. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1104 stores information within the computing device 1100. In one implementation, the memory 1104 is a volatile memory unit or units. In another implementation, the memory 1104 is a non-volatile memory unit or units. The memory 1104 may also be another form of computer-readable medium, such as a magnetic or optical disk.

The storage device 1106 is capable of providing mass storage for the computing device 1100. In one implementation, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1104, the storage device 1106, or memory on processor 1102.

The high-speed controller 1108 manages bandwidth-intensive operations for the computing device 1100, while the low-speed controller 1112 manages lower bandwidth-intensive operations. Such allocation of functions is exemplary only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer such as a laptop computer 1122. Alternatively, components from computing device 1100 may be combined with other components in a mobile device (not shown), such as device 1150. Each of such devices may contain one or more of computing device 1100, 1150, and an entire system may be made up of multiple computing devices 1100, 1150 communicating with each other.

Computing device 1150 includes a processor 1152, memory 1164, an input/output device such as a display 1154, a communication interface 1166, and a transceiver 1168, among other components. The device 1150 may also be provided with a storage device, such as a microdrive or other device, to provide additional storage. Each of the components 1150, 1152, 1164, 1154, 1166, and 1168, are interconnected using various buses, and several of the components may be mounted on a common motherboard or in other manners as appropriate.

The processor 1152 can execute instructions within the computing device 1150, including instructions stored in the memory 1164. The processor may be implemented as a chipset of chips that include separate and multiple analog and digital processors. The processor may provide, for example, for coordination of the other components of the device 1150, such as control of user interfaces, applications run by device 1150, and wireless communication by device 1150.

Processor 1152 may communicate with a user through control interface 1158 and display interface 1156 coupled to a display 1154. The display 1154 may be, for example, a TFT LCD (Thin-Film-Transistor Liquid Crystal Display) or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may be provide in communication with processor 1152, to enable near area communication of device 1150 with other devices. External interface 1162 may provide, for example, for wired communication in some implementations, or for wireless communication in other implementations, and multiple interfaces may also be used.

The memory 1164 stores information within the computing device 1150. The memory 1164 can be implemented as one or more of a computer-readable medium or media, a volatile memory unit or units, or a non-volatile memory unit or units. Expansion memory 1174 may also be provided and connected to device 1150 through expansion interface 1172, which may include, for example, a SIMM (Single In Line Memory Module) card interface. Such expansion memory 1174 may provide extra storage space for device 1150 or may also store applications or other information for device 1150. Specifically, expansion memory 1174 may include instructions to carry out or supplement the processes described above and may include secure information also. Thus, for example, expansion memory 1174 may be provide as a security module for device 1150 and may be programmed with instructions that permit secure use of device 1150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1164, expansion memory 1174, or memory on processor 1152, that may be received, for example, over transceiver 1168 or external interface 1162.

Device 1150 may communicate wirelessly through communication interface 1166, which may include digital signal processing circuitry where necessary. Communication interface 1166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1168. In addition, short-range communication may occur, such as using a Bluetooth, Wi-Fi, or other such transceiver (not shown). In addition, GPS (Global Positioning System) receiver module 1170 may provide additional navigation- and location-related wireless data to device 1150, which may be used as appropriate by applications running on device 1150.

Device 1150 may also communicate audibly using audio codec 1160, which may receive spoken information from a user and convert it to usable digital information. Audio codec 1160 may likewise generate audible sound for a user, such as through a speaker, e.g., in a handset of device 1150. Such sound may include sound from voice telephone calls, may include recorded sound (e.g., voice messages, music files, etc.) and may also include sound generated by applications operating on device 1150.

The computing device 1150 may be implemented in a number of different forms, as shown in the figure. For example, it may be implemented as a cellular telephone 1180. It may also be implemented as part of a smart phone 1182, personal digital assistant, or other similar mobile device.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising:
predicting a stereo depth associated with a first panoramic image and a second panoramic image, the first panoramic image and the second panoramic image being captured with a time interlude between the capture of the first panoramic image and the second panoramic image;
generating a first mesh representation based on the first panoramic image and a stereo depth corresponding to the first panoramic image;
generating a second mesh representation based on the second panoramic image and a stereo depth corresponding to the second panoramic image; and
synthesizing a third panoramic image based on fusing the first mesh representation with the second mesh representation.

2. The method of claim 1, wherein the first panoramic image and the second panoramic image are 360-degree, wide-baseline equirectangular projection (ERP) panoramas.

3. The method of claim 1, wherein the predicting of the stereo depth estimates a depth of each of the first panoramic image and the second panoramic image using a spherical sweep cost volume based on the first panoramic image and the second panoramic image and at least one target position.

4. The method of claim 1, wherein
the predicting of the stereo depth estimates a low-resolution depth based on a first features map associated with the first panoramic image and the second panoramic image, and
the predicting of the stereo depth estimates a high-resolution depth based on the first features map and a second features map associated with the first panoramic image.

5. The method of claim 1, wherein
the generating of the first mesh representation is based on the first panoramic image and discontinuities determined based the stereo depth corresponding to the first panoramic image, and
the generating of the second mesh representation is based on the second panoramic image and discontinuities determined based on the stereo depth corresponding to the second panoramic image.

6. The method of claim 1, wherein
the generating of the first mesh representation includes rendering the first mesh representation into a first 360-degree panorama based on a first target position,
the generating of the second mesh representation includes rendering the second mesh representation into a first 360-degree panorama based on a second target position, and
the first target position and the second target position are based on the time interlude between the capture of the first panoramic image and the second panoramic image.

7. The method of claim 1, wherein
the synthesizing of the third panoramic image includes fusing the first mesh representation together with the second mesh representation,
resolving ambiguities between the first mesh representation and the second mesh representation, and
inpainting holes in the synthesized third panoramic image.

8. The method of claim 1, wherein the synthesizing of the third panoramic image includes generating a binary visibility mask to identify holes the first mesh representation based on negative regions in the stereo depth corresponding to the first panoramic image and the second mesh representation based on negative regions in the stereo depth corresponding to the second panoramic image.

9. The method of claim 1, wherein
the synthesizing of the third panoramic image includes using a trained neural network, and
the trained neural network uses circular padding at each convolutional layer, to join left and right edges of the third panoramic image.

10. A system comprising:
a depth predictor configured to predict a stereo depth associated with a first panoramic image and a second panoramic image, the first panoramic image and the second panoramic image being captured with a time interlude between the capture of the first panoramic image and the second panoramic image;
a first differential mesh renderer configured to generate a first mesh representation based on the first panoramic image and a stereo depth corresponding to the first panoramic image;
a second differential mesh renderer configured to generate a second mesh representation based on the second panoramic image and a stereo depth corresponding to the second panoramic image; and
a fusion network configured to synthesize a third panoramic image based on fusing the first mesh representation with the second mesh representation.

11. The system of claim 10, wherein the first panoramic image and the second panoramic image are 360-degree, wide-baseline equirectangular projection (ERP) panoramas.

12. The system of claim 10, wherein the predicting of the stereo depth estimates a depth of each of the first panoramic image and the second panoramic image using a spherical sweep cost volume based on the first panoramic image and the second panoramic image and at least one target position.

13. The system of claim 10, wherein
the predicting of the stereo depth estimates a low-resolution depth based on a first features map associated with the first panoramic image and the second panoramic image, and
the predicting of the stereo depth estimates a high-resolution depth based on the first features map and a second features map associated with the first panoramic image.

14. The system of claim 10, wherein
the generating of the first mesh representation is based on the first panoramic image and discontinuities determined based the stereo depth corresponding to the first panoramic image, and
the generating of the second mesh representation is based on the second panoramic image and discontinuities determined based on the stereo depth corresponding to the second panoramic image.

15. The system of claim 10, wherein
the generating of the first mesh representation includes rendering the first mesh representation into a first 360-degree panorama based on a first target position,
the generating of the second mesh representation includes rendering the second mesh representation into a first 360-degree panorama based on a second target position, and
the first target position and the second target position are based on the time interlude between the capture of the first panoramic image and the second panoramic image.

16. The system of claim 10, wherein
the synthesizing of the third panoramic image includes fusing the first mesh representation together with the second mesh representation,
resolving ambiguities between the first mesh representation and the second mesh representation, and
inpainting holes in the synthesized third panoramic image.

17. The system of claim 10, wherein the synthesizing of the third panoramic image includes generating a binary visibility mask to identify holes the first mesh representation based on negative regions in the stereo depth corresponding to the first panoramic image and the second mesh representation based on negative regions in the stereo depth corresponding to the second panoramic image.

18. The system of claim 10, wherein
the synthesizing of the third panoramic image includes using a trained neural network, and
the trained neural network uses circular padding at each convolutional layer, to join left and right edges of the third panoramic image.

19. A non-transitory computer-readable storage medium comprising instructions stored thereon that, when executed by at least one processor, are configured to cause a computing system to:
predict a stereo depth associated with a first panoramic image and a second panoramic image, the first panoramic image and the second panoramic image being captured with a time interlude between the capture of the first panoramic image and the second panoramic image, the first panoramic image and the second panoramic image being 360-degree, wide-baseline equirectangular projection (ERP) panoramas;
generate a first mesh representation based on the first panoramic image and a stereo depth corresponding to the first panoramic image;
generate a second mesh representation based on the second panoramic image and a stereo depth corresponding to the second panoramic image; and
synthesize a third panoramic image based on fusing the first mesh representation with the second mesh representation.

20. The non-transitory computer-readable storage medium of claim 19, wherein
the generating of the first mesh representation includes rendering the first mesh representation into a first 360-degree panorama based on a first target position,
the generating of the second mesh representation includes rendering the second mesh representation into a first 360-degree panorama based on a second target position, and
the first target position and the second target position are based on the time interlude between the capture of the first panoramic image and the second panoramic image.
